(19) United States
(12) Patent Application Publication
(10) Pub. No.: US 2008/0131857 A1
(43) Pub. Date: Jun. 5, 2008

(54) Method for providing technical information of complex service procedures

(76) Inventor: Frank John Williams, Los Alamitos, CA (US)

Correspondence Address: Frank John Williams, 2711 Saint Albans Dr., Los Alamitos, CA, 90720, US

(21) Appl. No.: 11/497,052

(22) Filed: Aug. 1, 2006

Related U.S. Application Data
(60) Provisional application No. 60/704,815, filed on Aug. 1, 2005.
(60) Provisional application No. 60/764,931, filed on Feb. 3, 2006.
(60) Provisional application No. 60/780,473, filed on Mar. 8, 2006.

(51) Int. Cl. G09B 5/00

(52) U.S. Cl. 434/308

(57) ABSTRACT

A method for providing a service information platform comprising a cluster of movies demonstrating service procedures of an apparatus; wherein at last one movie demonstrates a consequential service event from another movie.

### RELATED APPLICATIONS

This application claims the benefit of: provisional patent application Ser. No. 60/704,815, filed Aug. 1, 2005, provisional patent application Ser. No. 60/764,931 filed Feb. 3, 2006, and provisional patent application 60/780,473 filed Mar. 8, 2006, by the present inventor

### BACKGROUND

1. Field of the Present Disclosure

This disclosure relates to several methods for providing information. More specifically, a method for providing technical information to clients regarding complex procedures.

2. Description of Related Art

Because of the complexity, technical evolution, and multi-functionality of the modem machine, the service procedures involved in keeping them functional have also experience a proportional augmentation in complexity and grade of difficulty. As a result, larger quantities of money and resources are required to trained, educate and assist the field and in-house service personnel in a struggle for balancing the ever demanding and changing service industry.

Technicians find themselves constantly challenged with the never ending annoyances of traffic, parts accessibility, mind status quo, and others to name few; while having to tussle with the constant flux of new and increased amounts of information. Service manuals have now taken new dimensions in size and content than even the most experienced technical minds may find it difficult to keep up. The technical information acquisition from the latter manuals requires expert and patient extrapolation to find and secure the best repairing possible. The end-users on the other hand have become more dependent in machines and technology than ever before. Tighter schedules and added expectations increase the demand on the equipment and human alike.

The revolution of the faster Internet has made possible to handle or deliver almost any type of file one could through at it. Among such files one can effortlessly find the existence and traffic of movies; movies which indeed could potentially address many of service procedures required to service today's sophisticated machinery.

But even thou a movie still represent the most suitable object to deliver fast and compelling information, the procedures now taking place within the machines are far to complex, extensive and eventful for a movie to handle. For example, a repair on a copier displaying the error code “E500” (meaning that the oil in the fuser unit has expired) can take a manual 10 different pages, in different location to successfully cover the malfunctioning event. A movie on the other can potentially provide all this information in a more compact and concise way. However, the problem with such movie is that it will still have to cover sufficient ground to address the needs of its many viewers. The complexity of the machine implies many possibilities and while for some end-users can do very well with ten minutes of footage, for others is not. Then, to address every item in the movie, implies the production of long, boring and even obvious movies to many others.

In addendum to the previously discussed, manuals and movies are indeed static. New discoveries, new procedures, and new problems threaten their content and ability to adapt, grow and deliver.

Recently, a new series of approaches have being conceived intending to alleviate the inconveniences of technical information distribution. Patents such as: U.S. Pat. No. 6,317,570 Uchida et al, U.S. Pat. No. 5,802,429 Yamashita, U.S. patent application publication 2004/0186598 A1 Tanaka, and U.S. Pat. No. 5,715,496 Sawada et al, disclose several methods of obtaining information directly from the apparatuses for intents of remote diagnosis, and possible equipment management. Unfortunately they all fail of providing repair information to the client, thus fixing the machine. In addition such systems are restricted to the self diagnosis capabilities of the machine, which can only recognized a problem through operative failure and not by inspection.

Although technical movies are not a new endeavor to many, they still pertain to an educational environment rather than a repairing and troubleshooting objective. Websites such as www.evergreelaser.com use movies to demonstrate the service procedures of commercial laser apparatuses. However, their system fails to address particular issues or circumstances derived from complex procedures and/or the movie content. In other words, events that may easily develop or occur during the performing a given service procedure, that yet are not anticipated or discussed within the movie, which indeed could extend the movie time and information to uncomfortable levels to many clients.

In view of the foregoing and shortcomings, the disclosed inventive methods teaches away from the commonly used methodologies, while solving felt needs and provides unappreciated advantages distinguishing it over the prior art by also providing heretofore additional unknown advantages as described in the following summary.

### SUMMARY

It is therefore the object of the present invention to teach a method for providing technical information to clients in a quick, objective, affordable and convenient manner, without limitations from any particular means of communication. Furthermore, the method comprises the adaptability and manageability of technical information. This disclosure teaches certain benefits in construction and use which give rise to the objectives described below.

A primary objective inherent in the above described method of use is to provide advantages not taught by the prior art;

Another objective is to provide technical information of complex procedures;

Another objective is to provide technical information of eventful service procedures;

Another objective is to provide technical information of eventful service procedures;

Another objective is to easy the load upon technical support personnel;

Another objective is to avoid incorrect extrapolation of technical data;

Another objective is to fulfill clients needs to service their own equipment;

Another objective is to standardize the quantity of technical information;

Another objective is to introduce the client to their apparatus avoiding future possible downtime and/or equipment misusage;

Another objective is to alleviate warranty related repairs and/or expenses;

Another objective is to provide alternative and/or temporary repair procedures to bring equipment to operating status as soon as possible;

A further objective is to allow manufactures and technical support departments to introduce a new platform of support, such as “extended intellectual technical support service;

A further objective is to eliminate the possibility of identifying and ordering incorrect parts which are not related to the relevant service procedure;

A further objective is to increase the troubleshooting success rate of field service personnel and end-users alike;

Other features and advantages of the described methods of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present method of use. In such drawings:

FIG. 1 illustrates a general non-limiting view of a servicing procedure platform;

FIG. 2a illustrates a general overview of a service procedure platform;

FIG. 2b illustrates a general overview of an educational technical movie.

### DETAILED DESCRIPTION OF THE PREFERRED EMBODIMENT

The above described drawing figures illustrate the described methods and use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present apparatus and method of use.

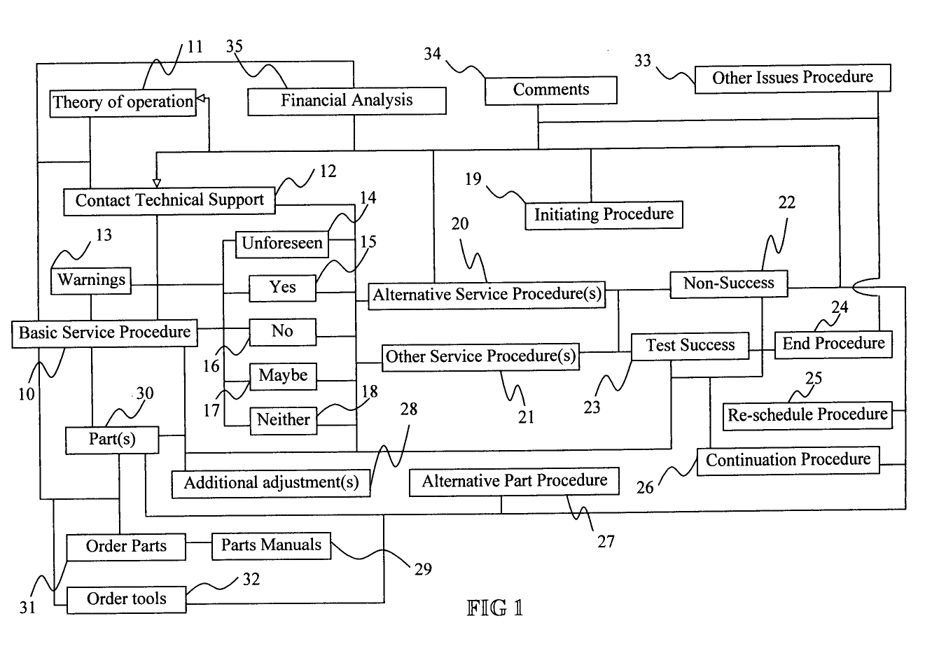

FIG. 1 illustrates a general non-limiting view block diagram of a service procedure platform. From the drawing, it can appreciated that the basic or first service procedure 10 (FIG. 1) is displayed in conjunction to a series of additional elements, thus producing the exemplary service platform. The difference establishing a platform from that of an educational video or instructional movie is indeed the presence of the depicted additional elements. While an instructional movie is incapable of addressing new additional data unless a more substantial movie is filmed again, the platform on the other hand can easily accommodate updates and new information. Simply by adding an identification onto the body of the platform's flow chart, the new important information can easily be demonstrate using a uncomplicated movie. Furthermore, the amount of information can be controlled or managed. For example, a technician from a distant location contact technical support requesting information as to how to replace the laser unit in a particular laser printer per se. The responding support department can provide via the Internet access to the “replacing the laser of the XX printer” and yet conveniently removing (or disabling) the parts interface 29 (FIG. 1) and the theory of operations interface 11 (FIG. 1), thus streamlining the platform. In another sample an end-user has a reoccurring paper jamming issue, the platform is provided without a re-schedule procedure 25 (FIG. 1) and without a parts manual 28 (FIG. 1), thus avoiding the inform client as to other parts in the machine. A more compelling example is that of a paying client versus a non paying client. While paying client is given access to all protocols per se, the non-paying client has limited access to ordering parts 30 (FIG. 1) in the sense that he can only buy parts at retail price, no access to parts manuals 28 (FIG. 1) and no access to contact technical support 12 (FIG. 1). From the present description it can be appreciated that the displayed protocols or procedures may in fact contain a series on additional procedures and/or non displayed connectivity due to the limitations of illustrations in general but most importantly is because the arrangement of elements, the quantity of elements, the connectivity between elements and the preciseness of elements really depends in the type of apparatus, client, environment, and technical difficulty being asserted. For example, while the “replacing the laser” platform of a particular printer provides two links to different movies demonstrating how to inspect the area before installing the unit, in another printer, the “inspecting area before installation” has only a single movie. However, for as many combinations that could be conceived, they never depart from the main spirit of the inventive method which is indeed to provide a platform containing several movie identifiers demonstrating at least one service procedure. In addition, other elements of the inventive method, yet a small group, do not include movies necessarily. Specifically, the parts 29 (FIG. 1) interface or protocol, which deals more or less with the ordering of parts and the Contact technical Support protocol 12 (FIG. 1) which obviously provides various communication means to contact technical support personnel. Referring back to FIG. 1, the particular elements will be discussed in more detail. The basic or “initial” service procedure 10 (FIG. 1) deals with the intended service, whether this is an adjustment, installations, update and/or repair. More specifically, a glossary is included towards the end of this detail description to further aid the description of the particular service procedures mentioned herein. Other essential non-limiting elements are: Theory of operation 11 (FIG. 1), which deals with discussions and demonstrations of the basic operation and analysis of the systems involved in the basic service procedure 10 (FIG. 1). For example in the event that the basic service procedure 10 (FIG. 1) deals with the repairs of an error code, the theory of operation discusses the functionality, purpose and analysis of the parameters, parts, and processes for producing and/or determining such an error code. The Contact technical support 12 (FIG. 1) deals with communicating procedures such as: e-mail, VOIP, video conference, wireless communications, telephone(s) information, e-chat, and other to name a few. The warnings protocol 13 (FIG. 1) deals with important safety and alarming type of information, such as making sure the power is unplugged, make sure not to leave the part exposed to the sunlight, etc. Also, and important manifestation of the warning protocol 13 (FIG. 1) may be the use specific identifying means such as color, blinking border, and others to attract attention over the other elements. The unforeseen 14 (FIG. 1) protocol is an essential part of the objective of a service platform, since it deals primarily with at least one occurring event or action unlike the ones being demonstrated by the service procedure movie. In other words, it deals with any occurring event that is not being discussed or being demonstrated in the parent service procedure. For example, a movie demonstrating a service procedure of how to replace the laser unit of a given printer does not cover a particular cable that although not a part of the laser unit replacing procedure could get stuck in the way of the technician. An unforeseen procedure could be announced such as “the red cable is in the way”, thus addressing the particular issue only to those technicians experiencing the event. This previous sample also works to demonstrate the time saving abilities and dynamic capabilities of the platform. To cover the information concerning the “red cable” on every movie it means that it will unnecessarily extend the duration of the movie and the basic procedure (replacing the laser unit) to undesirable amounts, since it is a non-frequent even. Also, in the possibility that the information regarding the “red cable” is non-existing (is not covered by the platform), when the problem appears for the first time a “red cable” movie can potentially be produce and then be conveniently added to the platform without having to modify practically anything within. Returning to FIG. 1, the “Yes” 15 (FIG. 1), “No” 16 (FIG. 1) “Maybe” 17 (FIG. 1) and “Neither” 18 (FIG. 1) are intended to handle, direct and/or reroute the chain of sequences and service actions leading to the finalization of the basic service procedure. For example, in a uneventful service procedure the movie invites the client to provide a comment to technical support, upon which the client decides not to contact anybody; therefore by clicking “No” the client is brought to greeting and/or end procedure 24 (FIG. 1). Noteworthy, the “Yes—Neither” 15-18 (FIG. 1) procedures intent what a interactive movie will do. However, the differences are more substantial than the simply perceived. An interactive video stills needs to be re-edited on very addition or removal, and also, the number of links and space to add such links within the displayed area of the movie itself in extremely limited. If every link was to be added in such an interactive video, there will be little or no space left for the images of the movie to be observed without major interruption(s) or aggravation(s).

The Initiating procedures 19 (FIG. 1) deals with other servicing platform(s) addressing the same service issue addressed by the first platform. For example, all information, procedures and events within the platform still bring the client to a non-successful repair, the Initiating procedures 19 (FIG. 1) will bring the client to other platforms still trying to address the problem and/or repair. The Alternative Servicing Procedure 20 (FIG. 1) deals with quick and temporary service procedures intending to avoid and/or continue the intended repair, thus eliminating the possibilities of downtime. For example, a common term used for such type of procedures is better known as a “Mickey mouse job” or “put tape until later.” Other service procedures 21 (FIG. 1) deals with remaining and carrying on procedures, such as “after installing the laser unit please proceed to adjusted” per se. This in fact does not refer to only one “other service procedure” but also to several procedures. Non-Success 22 (FIG. 1) deals with failure of the service platform(s); directing the client to mainly contact support, order missing parts, order missing tools, initiating procedures, and other to name a few. This protocol is an essential non-limiting interface is dedicated to identify the failure of a platform to address the client's servicing inability, the equipment's malfunction, and/or the incompletion of service information. Test Success 23 (FIG. 1) deals with affirmation that all service actions are indeed effective and complete; and also is served to identify the platform service score. End Procedure 24 (FIG. 1) deals finalizing the platform and providing means for the client to continue into other issues of concern with the equipment. It can also be used to record the client satisfaction information, client identification, and financial analysis and comments to the name a few. Re-schedule procedure 25 (FIG. 1) deals with the interruption of the client to finalize the procedure due to others non servicing events, such as client run of time, client is getting a phone call, etc. This procedure enables the client to restart or proceed with the platform at a later; noteworthy is that a “ticket” can be issue allowing the client to simply enter the “ticket” value in a search engine per se, thus bringing the platform and any added/removed information from it. The Continuation procedure 26 (FIG. 1) deals with the purposely interruption of a service procedure, mainly from technical support or because of a part. For example, a platform has failed to address a particular issue affecting the client, after contacting technical support, an additional and specially directed to the client procedure can be plugged in the platform for intending finalization. In another sample, the client orders a part which is not at hand; thus “ticketing” the platform for continuation at a later time. The Alternative Part procedure 27 (FIG. 1) deals with three important parts related issues: the first is to deal with operations and/or procedures that could potentially be implemented to repair (or other) the apparatus because the absence of a part; the second deals with temporary parts and/or switching of parts to bring the equipment back to operation; and the third and last, it deals with emergency allocation of parts, such as using the part from another model, etc. Additional procedures 28 (FIG. 1) deals with other non-relating adjustments or procedures gently offered or suggested to aid the client and machine; for example: a client is replacing the laser unit of his printer, an additional procedure will mention adjusting or cleaning the fixing fan, which becomes visible when replacing the laser unit and tents to get really dirty. Although such an “additional procedure” is not related nor is immediate to any function of the machine at the time, it is suggestive to do since all variables are present to proceed. Another example is that when replacing the roller per se, wherein an additional procedure would be how to clean the adjacent rail where the paper supply cassette fits. The next element upon discussion is the Parts Manuals 29 (FIG. 1) which deals with the identification of parts of the machine in general. Important in the part manual procedure is to appreciate the difference between an indirect part manual and a direct parts manual. An indirect parts manual is very muck alike what one can find in the market place, simply a link bring the parts diagrams as a whole; while the direct parts manuals brings the parts involved in the service procedure, then the optional percentage of success ratio, then other likely parts and finally the indirect parts manual. The next element is the Parts procedure 30 (FIG. 1); which is obviously of relevance when servicing an apparatus. The parts procedure is literally accessible from every single protocol/procedure available. Design not only to identify the parts before a procedure is performed but also to identify indirect parts within the particular procedure. For example, the procedure of replacing the laser unit on the printer involves removing two cables; but while removing the cable the client notices that a third non-related cable is indeed damaged. At this particular instant, the client can simply click the parts link and proceed directly to the diagram wherein all the parts in that cavity of the machine are present, thus quickly identifying the part and proceed to order it. Furthermore, since the part has been order form a platform that does not involve it, technical support and/or the program managing the delivery of the platforms can do at least one of a: identifying the event, recording the event, analyzing the event, communicating with the client, providing a re-schedule procedure 25 (FIG. 1) or others. The next element upon disclosure is the order parts procedure 31 (FIG. 1) which deals with placing the order for parts. This also important protocol provides a series of alternative part information, availability, emergency delivery and pickup, parts catalog links, alternative parts procedures 27 (FIG. 1) and others. Furthermore, the existence of such a part procedure associated to at least one service procedure of whatever nature, has the tremendous ability of transforming a single procedure (educational movie) a platform, and any other system and person into “profitable” business dealing. In other words: a part ordering protocol and/or any information identifying the means for obtaining a part order protocol being associated with a respective service procedure converts service information into a business. Nonetheless, the ever expensive technical support department manufactures use, can become profitable and business meaningful; which furthermore give rise to a variety of important and new business tools that could become and ever essential dealing for any manufacturer involved in service information dissemination, in particular through movies. The Other Issues procedure deals with introducing access to other non-relating procedures; for example, after finishing a successful laser unit replacement, the client can go and do a preventive maintenance, or replace the feed roller per se. And finally, the Comments 34 (FIG. 1) and Financial analysis 35 (FIG. 1) interrelating with each other they deal with one of the most relevant and imperative issues incurring a client which is the expenses involved. The Comments 34 (FIG. 1) deals with communications of important comments to the implementation of platforms, upgrades and others; while the Financial Analysis deals with the incurring cost of maintaining the apparatus. Both together, are capable not only to identify the expense of a repair but also the current expenses to maintain the equipment; and furthermore to invite the client to upgrade and/or replace the equipment with a less costly and/or less troublesome apparatus. For example, the client determines that his printer needs a laser unit. Upon placing an order for the part, the platform managing program, technical support and/or other(s) identify such an upcoming event. Due to the age of the client's printer (the platform is for a 15 year old machine) and the cost of the unit, (and/or other possible parameters such as machine meter, frequency of repairs, cost of supplies, etc) it makes perfect sense to upgrade the machine with a more slim and newer more affordable model; as a consequence, the client is introduced to another movie per se demonstrating a commercial and special upgrading offers to clients with the printer of discussion. The number of educated business decisions and opportunities the Comment 34 (FIG. 1) and Financial Analysis 35 (FIG. 1) procedures/protocols can offer transforms the service information dissemination into a truly competitive and valuable industry.

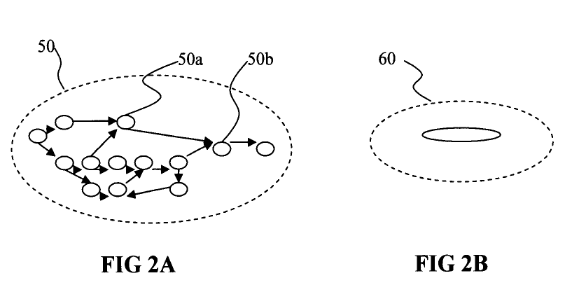

FIG. 2 illustrates a platform 50 (FIG. 2a) and some of its elements 50a (FIG. 2a) and 50b (FIG. 2a); the educational or instructional 60 (FIG. 2b) movie is also shown. From FIG. 2B, the differences between both methodologies can be quickly appreciated.

Noteworthy, many others elements and things can be added or can be used to simplify many of the steps within the steps of the inventive method disclosed herein. For example, of particular importance is a database(s) which contains important information on the movies and the information or type of information they contain. Data such as at least one of a: Description of the action(s) or procedure(s), manufacturer, last date of revision, additional movie and their respective identification(s), associative motion picture, potential associative motion picture, description of the particular action(s) of mentioned “associative” movie(s) covers, location or area of the machine it demonstrates (for example, the fuser assembly), element of the apparatus or part needed to perform the service procedure(s) it demonstrates, identification of a part, identification of a part indirectly involved in the motion picture (for example, a link to the parts' manual and/or particular locations within the manual or simply part number).

The enablements described in detail above are considered novel over the prior art of record and are considered critical to the operation of at least one aspect of the method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### CONCLUSION

From the present disclosed inventive method, it can be appreciated a novel method for providing service procedure information implementing a cluster of movies, thus permitting to address many client event and necessities without a single overwhelming amount of information. In addition, the method allows for adaptability, growth and circumstantial manipulation of servicing information.

FIG. 2A and FIG. 2B illustrate a platform 50 (FIG. 2a) and some of its elements 50a (FIG. 2a) and 50b (FIG. 2a); and the educational or instructional 60 (FIG. 2b) movie is also shown respectively. From FIGS. 2A and 2B, the differences between both methodologies can be quickly appreciated.

Noteworthy, many others elements and things can be added or can be used to simplify many of the steps within the steps of the inventive method disclosed herein. For example, of particular importance is a database(s) which contains important information on the movies and the information or type of information they contain. Data such as at least one of a: Description of the action(s) or procedure(s), manufacturer, last date of revision, additional movie and their respective identification(s), associative motion picture, potential associative motion picture, description of the particular action(s) of mentioned “associative” movie(s) covers, location or area of the machine it demonstrates (for example, the fuser assembly), element of the apparatus or part needed to perform the service procedure(s) it demonstrates, identification of a part, identification of a part indirectly involved in the motion picture (for example, a link to the parts' manual and/or particular locations within the manual or simply part number).

The enablements described in detail above are considered novel over the prior art of record and are considered critical to the operation of at least one aspect of the method of use and to the achievement of the above described objectives. The words used in this specification to describe the instant embodiments are to be understood not only in the sense, of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the

1. A method for providing a cluster of technical information, the method comprising the steps of:
a) Providing a first information on a display field identifying a first movie demonstrating a service procedure of an apparatus
b) Providing a second information on said display field identifying at least one of a: information identifying a second movie demonstrating a service procedure, information identifying a part order protocol, information identifying a method to obtain a part, information identifying a second movie discussing an operation of an apparatus, information identifying a second movie demonstrating a consequential service event not present in the said fist movie, and an information identifying a service protocol.
